(19) United States
(12) Patent Application Publication
(10) Pub. No.: US 2022/0282982 A1
(43) Pub. Date: Sep. 8, 2022

(54) DISPLAY DEVICE, NAVIGATION SYSTEM, DISPLAY METHOD, AND STORAGE MEDIUM

(71) Applicant: SUMITOMO ELECTRIC INDUSTRIES, LTD., Osaka-shi, Osaka (JP)

(72) Inventor: Tomoyuki KITADA, Osaka-shi (JP)

(73) Assignee: SUMITOMO ELECTRIC INDUSTRIES, LTD., Osaka-shi, Osaka (JP)

(21) Appl. No.: 17/630,434

(22) PCT Filed: Oct. 10, 2019
(86) PCT No.: PCT/JP2019/040123

§ 371 Date: Jan. 26, 2022

(51) Int. Cl. G01C 21/34; G01C 21/36; B60L 58/12

(52) U.S. Cl. CPC G01C 21/3469; G01C 21/362; G01C 21/3664; B60L 58/12; B60L 2250/16

(57) ABSTRACT

A control unit executes: a route information display process of displaying route information of a route from a starting point to the destination, the route searched for based on a current level of a battery, and including a charging facility as a relay point; a first guidance information display process of displaying guidance information for guiding traveling of the vehicle from the starting point to the relay point, when the vehicle starts traveling at the starting point; a notification input screen display process of displaying an input screen that receives an input for notifying resumption of traveling of the vehicle, when the vehicle resumes traveling after having arrived at the relay point; and a second guidance information display process of displaying guidance information for guiding traveling of the vehicle from the relay point to the destination, when the input for notification has been received on the input screen.

### TECHNICAL FIELD

The present disclosure relates to a display device, a navigation system, a display method, and a storage medium.

### BACKGROUND ART

PATENT LITERATURE 1 discloses a navigation device for an electric vehicle. The navigation device disclosed in PATENT LITERATURE 1 searches for a route to a destination, and thereafter determines whether or not the electric vehicle can travel to the destination. If the electric vehicle is determined to be incapable of traveling to the destination, the navigation device adds, in the route to the destination, a pre-arrival chargeable point that is a battery chargeable point at which a battery can be charged before arriving at the destination. Then, the navigation device performs re-searching for a route to the destination such that the route includes the added pre-arrival chargeable point.

### CITATION LIST

### Patent Literature

PATENT LITERATURE 1: Japanese Laid-Open Patent Publication No. 2016- 206209

### SUMMARY OF THE INVENTION

A display device according to an aspect of the present disclosure is configured to display information for guiding traveling, to a destination, of a vehicle equipped with a battery for traveling. The display device includes a display unit, and a control unit configured to control display on the display unit. The control unit executes: a route information display process of causing the display unit to display route information of a route from a starting point to the destination, the route having been searched for based on a current level of the battery, and including a charging facility as a relay point; a first guidance information display process of causing the display unit to display guidance information for guiding traveling of the vehicle from the starting point to the relay point, when the vehicle starts traveling at the starting point; a notification input screen display process of causing the display unit to display an input screen that receives, from a user, an input for notifying resumption of traveling of the vehicle, when the vehicle resumes traveling after having arrived at the relay point; and a second guidance information display process of causing the display unit to display guidance information for guiding traveling of the vehicle from the relay point to the destination, when the input for notification has been received on the input screen.

A navigation system according to an aspect of the present disclosure is configured to guide traveling, to a destination, of a vehicle equipped with a battery for traveling. The navigation system includes a server device, and a display device communicable with the server device. The server device is configured to search for a route, from a starting point to the destination, which includes a charging facility as a relay point, based on a current level of the battery at the starting point. The display device includes a display unit, and a control unit configured to control display on the display unit. The control unit executes: a route information display process of causing the display unit to display route information of the route, from the starting point to the destination, which has been searched for by the server device; a first guidance information display process of causing the display unit to display guidance information for guiding traveling of the vehicle from the starting point to the relay point, when the vehicle starts traveling at the starting point; a notification input screen display process of causing the display unit to display an input screen that receives, from a user, an input for notifying resumption of traveling of the vehicle, when the vehicle resumes traveling after having arrived at the relay point; and a second guidance information display process of causing the display unit to display guidance information for guiding traveling of the vehicle from the relay point to the destination, when the input for notification has been received on the input screen.

A display method according to an aspect of the present disclosure is a method of displaying, by using a display device, information for guiding traveling, to a destination, of a vehicle equipped with a battery for traveling. The method includes: displaying, by the display device, route information of a route from a starting point to the destination, the route having been searched for based on a current level of the battery, and including a charging facility as a relay point; displaying, by the display device, guidance information for guiding traveling of the vehicle from the starting point to the relay point, when the vehicle starts traveling at the starting point; displaying, by the display device, an input screen that receives, from a user, an input for notifying resumption of traveling of the vehicle, when the vehicle resumes traveling after having arrived at the relay point; and displaying, by the display device, guidance information for guiding traveling of the vehicle from the relay point to the destination, when the input for notification has been received on the input screen.

A storage medium according to an aspect of the present disclosure is a computer-readable non-transitory storage medium having, stored therein, a computer program for displaying information for guiding traveling, to a destination, of a vehicle equipped with a battery for traveling. The computer program causes a computer including a display unit to execute: a route information display process of causing the display unit to display route information of a route from a starting point to the destination, the route having been searched for based on a current level of the battery, and including a charging facility as a relay point; a first guidance information display process of causing the display unit to display guidance information for guiding traveling of the vehicle from the starting point to the relay point, when the vehicle starts traveling at the starting point; a notification input screen display process of causing the display unit to display an input screen that receives, from a user, an input for notifying resumption of traveling of the vehicle, when the vehicle resumes traveling after having arrived at the relay point; and a second guidance information display process of causing the display unit to display guidance information for guiding traveling of the vehicle from the relay point to the destination, when the input for notification has been received on the input screen.

The present disclosure can be realized not only as a display device including the above characteristic components but also as a display method having the characteristic processes in the display device as steps, or as a storage medium having, stored therein, a computer program for causing a computer to execute the steps. A part of the display device can be realized as a semiconductor integrated circuit. Moreover, the present disclosure can be realized as a navigation system including a display device.

### BRIEF DESCRIPTION OF DRAWINGS

FIG. 1 is a schematic diagram showing an example of a configuration of a navigation system according to an embodiment.

FIG. 2 is a block diagram showing an example of a configuration of a server device according to the embodiment.

FIG. 3 is a block diagram showing an example of a configuration of a mobile terminal device according to the embodiment.

FIG. 4 is a functional block diagram showing an example of functions of the server device according to the embodiment.

FIG. 5 is a functional block diagram showing an example of functions of the mobile terminal device according to the embodiment.

FIG. 6 shows an example of an initial input screen.

FIG. 7 shows an example of a first route screen.

FIG. 8 shows an example of a route guidance screen.

FIG. 9 shows an example of a relay point arrival screen.

FIG. 10 shows an example of a current battery level reception screen.

FIG. 11 shows an example of a second route screen.

FIG. 12 shows an example of a destination arrival screen.

FIG. 13 is a flowchart showing an example of an operation flow of the server device according to the embodiment.

FIG. 14A is a flowchart showing an example of a first half of an operation flow of the mobile terminal device according to the embodiment.

FIG. 14B is a flowchart showing an example of a second half of the operation flow of the mobile terminal device according to the embodiment.

### DETAILED DESCRIPTION

### Problems to be Solved by the Present Disclosure

Charging an in-vehicle battery takes a longer time as compared to fueling a vehicle with gas. Therefore, while the in-vehicle battery is being charged, occupant(s) of the vehicle can efficiently use time for eating, shopping, or the like in neighboring facility, for example. It is conceivable that, while the in-vehicle battery is being charged and the occupant(s) leaves the vehicle for a long time, the power supply of the vehicle is turned off, and route guidance by the navigation device is stopped. In this case, in order to resume the route guidance, the user needs to set the destination again and instruct start of the guidance.

### Effects of the Present Disclosure

According to the present disclosure, when charging of an in-vehicle battery has been performed at a charging facility as a relay point, guidance can be resumed without the necessity of resetting a destination.

### Outline of Embodiment of the Present Disclosure

Hereinafter, the outlines of embodiments of the present disclosure are listed and described.

(1) A display device according to an embodiment of the present disclosure is configured to display information for guiding traveling, to a destination, of a vehicle equipped with a battery for traveling. The display device includes a display unit, and a control unit configured to control display on the display unit. The control unit executes: a route information display process of causing the display unit to display route information of a route from a starting point to the destination, the route having been searched for based on a current level of the battery, and including a charging facility as a relay point; a first guidance information display process of causing the display unit to display guidance information for guiding traveling of the vehicle from the starting point to the relay point, when the vehicle starts traveling at the starting point; a notification input screen display process of causing the display unit to display an input screen that receives, from a user, an input for notifying resumption of traveling of the vehicle, when the vehicle resumes traveling after having arrived at the relay point; and a second guidance information display process of causing the display unit to display guidance information for guiding traveling of the vehicle from the relay point to the destination, when the input for notification has been received on the input screen. Thus, when charging of the battery has been performed at the charging facility as the relay point, the user performs an input for notifying resumption of traveling of the vehicle. Therefore, the guidance can be resumed without the necessity of resetting the destination by the user.

(2) In the display device according to the present embodiment, when the vehicle has arrived at the relay point, the control unit may execute a current battery level reception process of receiving the current level of the battery. This allows the display device to grasp the current battery level before resumption of traveling.

(3) In the display device according to the present embodiment, the current battery level reception process may be a process of causing the display unit to display a current battery level reception screen that receives, from the user, an input of the current level of the battery. This allows the user to input the current battery level to the display device.

(4) In the display device according to the present embodiment, when the current level of the battery has been received in the current battery level reception process, the control unit may execute a second route information display process of causing the display unit to display route information of a route, from the relay point to the destination, which has been searched for based on the received current level of the battery. Thus, a route from the relay point to the destination can be searched for, based on the current battery level at the relay point.

(5) In the display device according to the present embodiment, the route information may include: first route information indicating a route in which the vehicle travels with the current level of the battery being equal to or higher than a predetermined value; and second route information indicating a route in which the vehicle travels with the current level of the battery being lower than the predetermined value. The first route information and the second route information may be displayed in different display formats so as to be distinguishable from each other. This allows the user to distinguish a traveling route for which the current battery level is sufficient from a traveling route for which the current battery level is insufficient.

(6) In the display device according to the present embodiment, when the vehicle has arrived at the relay point, the control unit may execute a relay point arrival screen display process of causing the display unit to display a relay point arrival screen including facility information indicating facilities located around the relay point. This allows the user to be provided with information of the facilities that the user can drop in while the battery is being charged at the charging facility.

(7) A navigation system according to an embodiment of the present disclosure is configured to guide traveling, to a destination, of a vehicle equipped with a battery for traveling. The navigation system includes a server device, and a display device communicable with the server device. The server device is configured to search for a route, from a starting point to the destination, which includes a charging facility as a relay point, based on a current level of the battery at the starting point. The display device includes a display unit, and a control unit configured to control display on the display unit. The control unit executes: a route information display process of causing the display unit to display route information of the route, from the starting point to the destination, which has been searched for by the server device; a first guidance information display process of causing the display unit to display guidance information for guiding traveling of the vehicle from the starting point to the relay point, when the vehicle starts traveling at the starting point; a notification input screen display process of causing the display unit to display an input screen that receives, from a user, an input for notifying resumption of traveling of the vehicle, when the vehicle resumes traveling after having arrived at the relay point; and a second guidance information display process of causing the display unit to display guidance information for guiding traveling of the vehicle from the relay point to the destination, when the input for notification has been received on the input screen. Thus, when charging of the battery has been performed at the charging facility as the relay point, the user performs an input for notifying resumption of traveling of the vehicle. Therefore, the guidance can be resumed without the necessity of resetting the destination by the user.

(8) A display method according to an embodiment of the present disclosure is a method of displaying, by using a display device, information for guiding traveling, to a destination, of a vehicle equipped with a battery for traveling. The method includes: displaying, by the display device, route information of a route from a starting point to the destination, the route having been searched for based on a current level of the battery, and including a charging facility as a relay point; displaying, by the display device, guidance information for guiding traveling of the vehicle from the starting point to the relay point, when the vehicle starts traveling at the starting point; displaying, by the display device, an input screen that receives, from a user, an input for notifying resumption of traveling of the vehicle, when the vehicle resumes traveling after having arrived at the relay point; and displaying, by the display device, guidance information for guiding traveling of the vehicle from the relay point to the destination, when the input for notification has been received on the input screen. Thus, when charging of the battery has been performed at the charging facility as the relay point, the user performs an input for notifying resumption of traveling of the vehicle. Therefore, the guidance can be resumed without the necessity of resetting the destination by the user.

(9) A storage medium according to an embodiment of the present disclosure is a computer-readable non-transitory storage medium having, stored therein, a computer program for displaying information for guiding traveling, to a destination, of a vehicle equipped with a battery for traveling. The computer program causes a computer including a display unit to execute: a route information display process of causing the display unit to display route information of a route from a starting point to the destination, the route having been searched for based on a current level of the battery, and including a charging facility as a relay point; a first guidance information display process of causing the display unit to display guidance information for guiding traveling of the vehicle from the starting point to the relay point, when the vehicle starts traveling at the starting point; a notification input screen display process of causing the display unit to display an input screen that receives, from a user, an input for notifying resumption of traveling of the vehicle, when the vehicle resumes traveling after having arrived at the relay point; and a second guidance information display process of causing the display unit to display guidance information for guiding traveling of the vehicle from the relay point to the destination, when the input for notification has been received on the input screen. Thus, when charging of the battery has been performed at the charging facility as the relay point, the user performs an input for notifying resumption of traveling of the vehicle. Therefore, the guidance can be resumed without the necessity of resetting the destination by the user.

### Details of Embodiments of the Present Disclosure

Hereinafter, an embodiment of the present disclosure will be described in detail with reference to the drawings. At least some parts of the embodiments described below may be combined together as desired.

[1. Configuration of Navigation System]

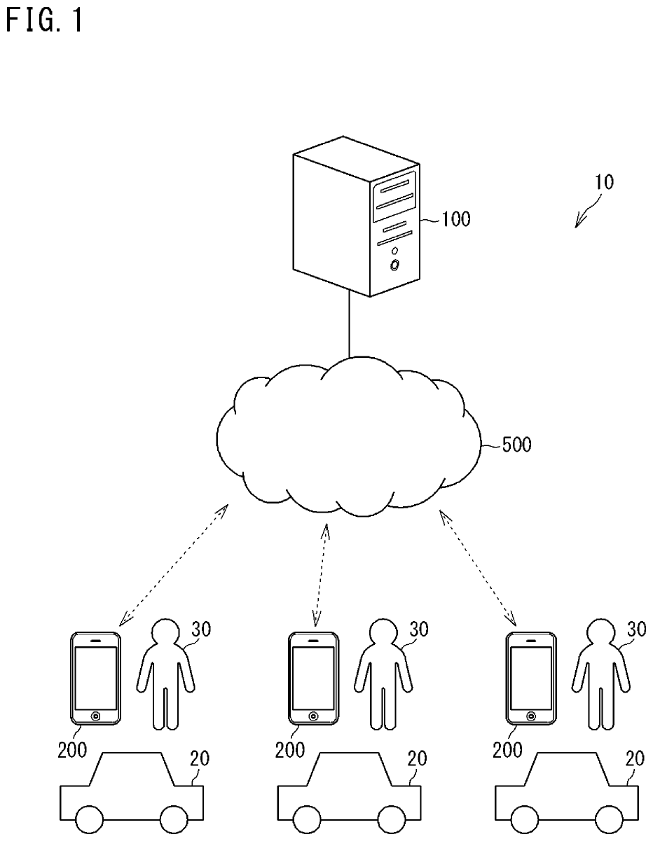

FIG. 1 is a schematic diagram showing a navigation system 10 according to an embodiment of the present disclosure. The navigation system 10 shown in FIG. 1 includes a server device 100, and mobile terminal devices 200 as display devices. A plurality of mobile terminal devices 200 are communicably connected to one server device 100 via a network 500 such as the Internet. Each mobile terminal device 200 is used by a user 30 who is an occupant of a vehicle 20. The server device 100 searches for a route, from a starting point to a destination, to be provided to the user 30, and transmits, to the mobile terminal device 200, information for guiding the searched route. The mobile terminal device 200 displays the information received from the server device 100, according to an operation by the user 30.

[2. Configuration of Server Device]

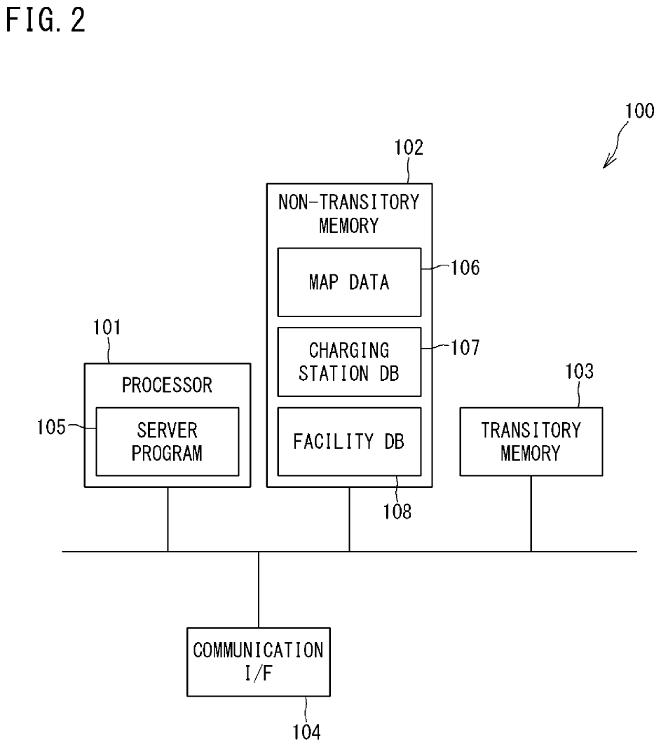

FIG. 2 is a block diagram showing an example of the configuration of the server device 100 according to the present embodiment. The server device 100 includes a processor 101, a non-transitory memory 102, a transitory memory 103, and a communication interface 104.

The transitory memory 103 is a volatile memory such as an SRAM (Static Random Access Memory) or a DRAM (Dynamic Random Access Memory), for example. The non-transitory memory 102 is a non-volatile memory such as a flash memory, a hard disk, or a ROM (Read Only Memory), for example. The non-transitory memory 102 stores therein a server program 105 which is a computer program, and data to be used for execution of the server program 105. The server device 100 is configured to include a computer, and functions of the server device 100 are exhibited by the processor 101 as a CPU executing the server program 105 which is a computer program stored in a storage device of the computer. The server program 105 can be stored in a storage medium such as a flash memory, a ROM, or a CD-ROM. The processor 101 executes the server program 105 to perform processes as described later.

The processor 101 is not limited to a CPU. For example, the processor 101 may be a hardware logic circuit such as an ASIC (Application Specific Integrated Circuit), a gate array, or an FPGA (Field Programmable Gate Array). In this case, the hardware logic circuit is configured to be able to execute the same processes as those of the server program 105.

The non-transitory memory 102 stores therein map data 106. The map data 106 is data of a map of a route guidance service provision area. The map data 106 includes information of the latitude and longitude of each point. Moreover, the non-transitory memory 102 includes a charging station database 107 and a facility database 108. Hereinafter, “database” is referred to as “DB”. A charging station is a charging facility where the battery of the vehicle 20 can be charged. In the charging station DB 107, the name of each charging station located in the route guidance service provision area is stored in association with the latitude/longitude of the charging station. In the facility DB 108, the name of each facility is stored in association with the latitude/longitude of the facility. Examples of facilities include commercial facilities such as restaurant, cafe, boutique, supermarket, drugstore, and convenience store.

The communication interface 104 is, for example, an Ethernet (registered trademark) interface, and is connected to the network 500. The server device 100 is communicable with other devices, e.g., the mobile terminal devices 200 and in-vehicle devices of the vehicles 20, via the network 500.

[3. Configuration of Mobile Terminal Device]

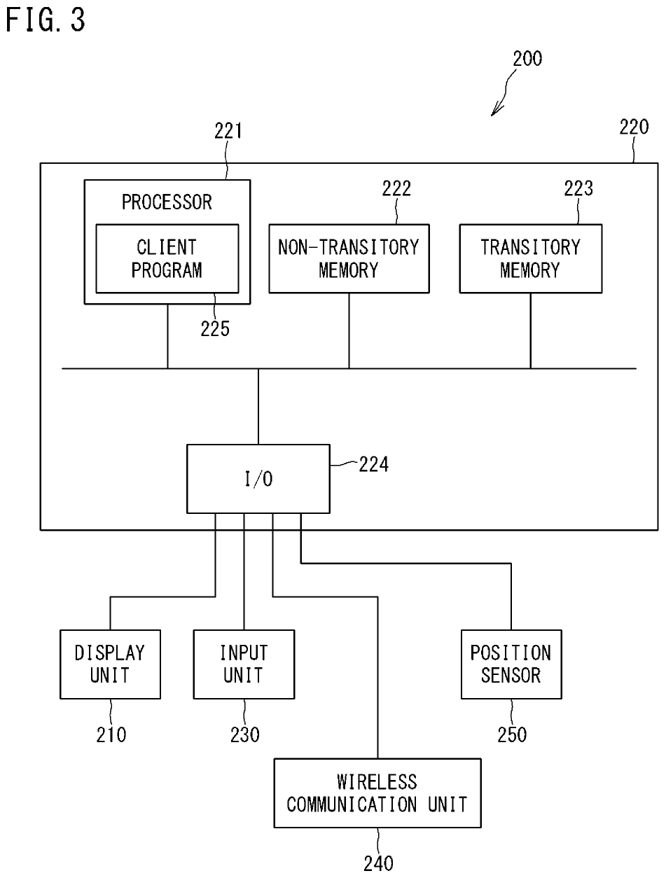

FIG. 3 is a block diagram showing an example of the configuration of a mobile terminal device 200 according to the present embodiment. The mobile terminal device 200 includes a display unit 210, a control unit 220, an input unit 230, a wireless communication unit 240, and a position sensor 250. The display unit 210 includes a liquid crystal display panel or an organic electroluminescence display panel. The input unit 230 is, for example, a touch sensor integrated with the display unit 210, and can receive an input performed by the user 30. The wireless communication unit 240 is capable of wireless communication, and can communicate with the server device 100 via the network 500.

The control unit 220 includes a processor 221, a non-transitory memory 222, a transitory memory 223, and an I/O interface 224.

The transitory memory 223 is a volatile memory such as an SRAM or a DRAM, for example. The non-transitory memory 222 is a non-volatile memory such as a flash memory, a hard disk, or a ROM, for example. The non-transitory memory 222 stores therein a client program 225 which is a computer program, and data to be used for execution of the client program 225. The mobile terminal device 200 is configured to include a computer, and functions of the mobile terminal device 200 are exhibited by the processor 221 as a CPU executing the client program 225 which is a computer program stored in a storage device of the computer. The client program 225 can be stored in a storage medium such as a flash memory, a ROM, or a CD-ROM. The processor 221 executes the client program 225 to implement processes as described later.

The processor 221 is not limited to a CPU. For example, the processor 221 may be a hardware logic circuit such as an ASIC (Application Specific Integrated Circuit), a gate array, or an FPGA (Field Programmable Gate Array). In this case, the hardware logic circuit is configured to be able to execute the same processes as those of the client program 225.

The I/O interface 224 performs input/output of data between the control unit 220 and the other units in the mobile terminal device 200. The I/O interface 224 is connected to each of the display unit 210, the input unit 230, the wireless communication unit 240, and the position sensor 250.

The position sensor 250 is, for example, a GNSS (Global Navigation Satellite System) receiver, and acquires current location information of the vehicle 20. The acquired location information is used for route guidance in navigation.

[4. Functions of Navigation System]

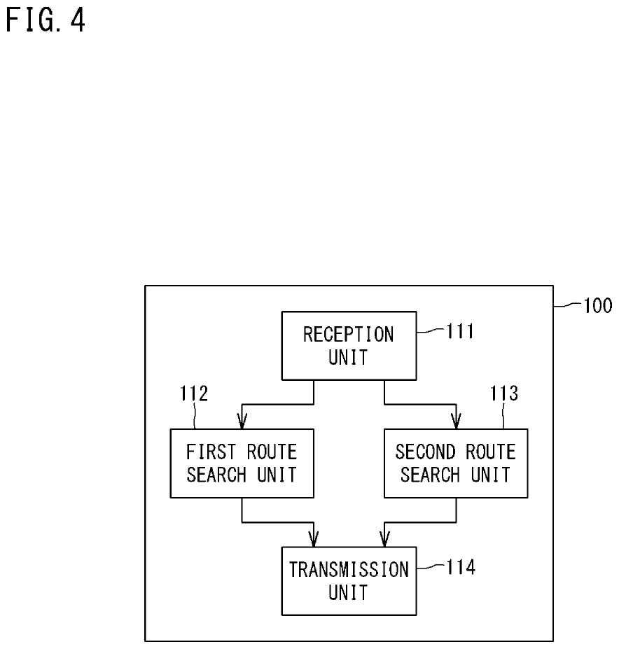

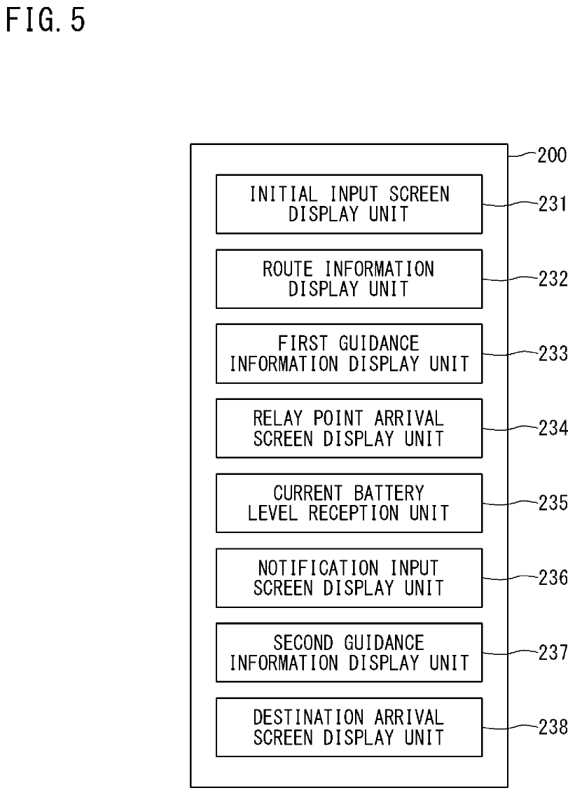

FIG. 4 is a functional block diagram showing an example of functions of the server device 100 according to the present embodiment. FIG. 5 is a functional block diagram showing an example of functions of the mobile terminal device 200 according to the present embodiment.

FIG. 4 is referred to. The server device 100 has functions as a reception unit 111, a first route search unit 112, a second route search unit 113, and a transmission unit 114.

FIG. 5 is referred to. The mobile terminal device 200 has functions as an initial input screen display unit 231, a route information display unit 232, a first guidance information display unit 233, a relay point arrival screen display unit 234, a current battery level reception unit 235, a notification input screen display unit 236, a second guidance information display unit 237, and a destination arrival screen display unit 238.

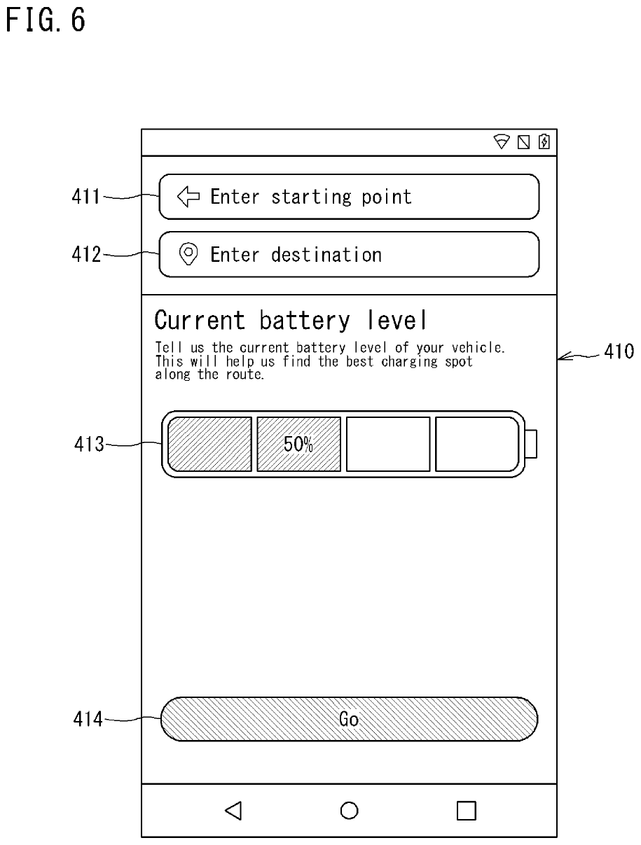

The initial input screen display unit 231 displays an initial input screen. FIG. 6 shows an example of the initial input screen. The initial input screen 410 is a screen on which the user 30 inputs a starting point, a destination, and an SOC (State Of Charge) which is an example of a current battery level. The initial input screen 410 includes an input area 411 for inputting a starting point, an input area 412 for inputting a destination, an input area 413 for inputting a current battery level, and a button 414 for instructing start. The initial input screen display unit 231 is implemented by the processor 221, the display unit 210, the input unit 230, and the wireless communication unit 240.

The user 30 can select the input area 411 and input a starting point by text information. Moreover, for example, on another screen displayed by selecting the input area 411, the user 30 may designate a current location as a starting point, or may designate a starting point on a map.

The user 30 can select the input area 412 and input a destination by text information. Moreover, for example, on another screen displayed when selecting the input area 412, the user 30 may designate a destination on a map.

The user 30 can select the input area 413 and input the current SOC. For example, in the input area 413, a button or a slider for inputting the SOC level of the battery in a plurality of stages is displayed, and the user 30 can input the current SOC by performing a touch operation on the screen.

The SOC may be provided from an in-vehicle device installed in the vehicle 20. For example, the mobile terminal device 200 may receive, through wireless communication, the current SOC that is stored in an in-vehicle device for managing the battery.

After inputting the starting point, the destination, and the current SOC, the user 30 can request start of navigation by selecting the button 414. When the button 414 has been selected, the starting point, the destination, and the SOC inputted to the initial input screen 410 are transmitted to the server device 100.

FIG. 4 is referred to again. The reception unit 111 receives data of the starting point, the destination, and the SOC from the mobile terminal device 200. The reception unit 111 is implemented by the communication interface 104.

The first route search unit 112 searches for a route from the starting point to the destination which are received by the reception unit 111. The first route search unit 112, based on the current SOC of the vehicle 20 (the SOC received by the reception unit 111), determines a charging station that is a relay point for the vehicle 20, and searches for a route, from the starting point to the destination, including the relay point. The charging station is determined within a range in which the vehicle 20 can arrive at the charging station with the SOC being equal to or higher than a predetermined value (e.g., 25%). That is, the first route search unit 112 estimates a distance that the vehicle 20 can travel with the SOC being equal to or higher than the predetermined value, and determines, as relay point(s), one or a plurality of charging stations located near the route connecting the starting point and the destination, from among charging stations located within the estimated distance from the starting point. Moreover, the first route search unit 112 searches for a route that connects the starting point and the destination and passes the relay point.

The number of charging stations to be determined as relay points by the first route search unit 112 is not limited to one, and a plurality of charging stations may be determined. That is, if the vehicle 20 cannot arrive at the destination from the starting point unless the battery thereof is charged a plural number of times, the first route search unit 112 determines a plurality of charging stations as relay points, and searches for a route that passes the charging stations. Moreover, the first route search unit 112 estimates an arrival time at the destination in the case where the vehicle 20 travels the searched route. The first route search unit 112 may search for a substitute route different from the searched route.

The “route information” is information indicating a route, from a starting point to a destination, in which the vehicle 20 travels. For example, the route information is represented as a line on a map. The first route search unit 112 generates: first route information indicating a route in which the vehicle 20 travels with the SOC being equal to or higher than the predetermined value; and second route information indicating a route in which the vehicle 20 travels with the SOC being lower than the predetermined value. That is, the first route search unit 112 estimates a distance that the vehicle 20 can travel with the SOC being equal to or higher than the predetermined value. Then, the first route search unit 112 generates, as the first route information, information indicating a route, out of the searched route, in which the distance from the starting point is within the estimated distance, and generates, as the second route information, information indicating a route, out of the searched route, in which the distance from the starting point exceeds the estimated distance. The route information including the first route information and the second route information generated by the first route search unit 112, an estimated time of arrival, and substitute route information are transmitted by the transmission unit 114 to the mobile terminal device 200 together with map data.

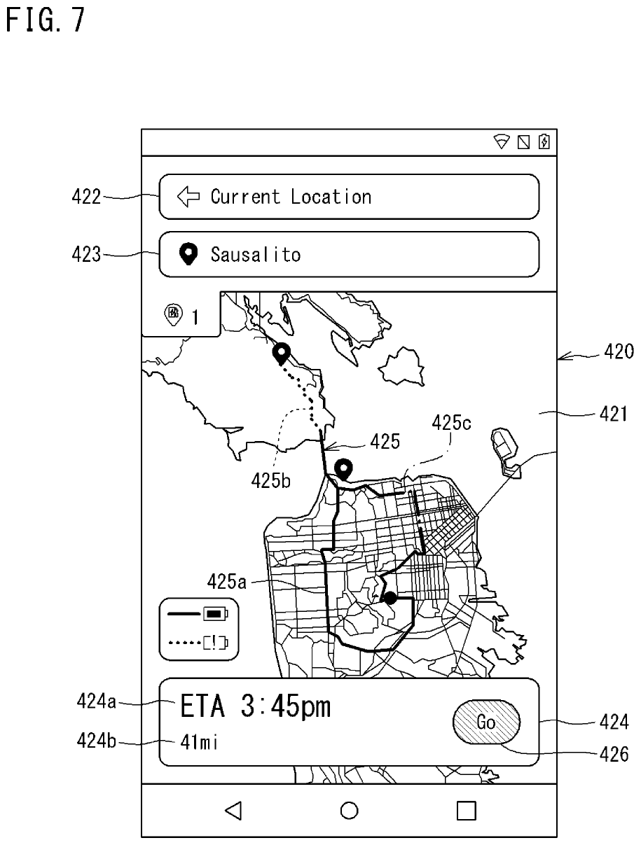

FIG. 5 is referred to again. The route information display unit 232 displays a first route screen including the route information and the map received from the server device 100. FIG. 7 shows an example of the first route screen. The first route screen 420 includes a route information display area 421, a current location information display area 422, a destination information display area 423, and an estimated arrival time display area 424. The route information display unit 232 is implemented by the processor 221, the display unit 210, and the input unit 230.

In the route information display area 421, information of searched routes is displayed while being superposed on the map. Regarding route information 425 displayed in the route information display area 421, first route information 425a indicating a route in which the vehicle 20 travels with the SOC being equal to or higher than a predetermined value, and second route information 425b indicating a route in which the vehicle 20 travels with the SOC being lower than the predetermined value, are displayed in different display formats so as to be distinguishable from each other. As a specific example, the first route information 425a is indicated by a solid line while the second route information 425b is indicated by a broken line. The display formats are not limited to a solid line and a broken line. For example, the respective routes of the first route information 425a and the second route information 425b may be displayed in different colors.

In the route information display area 421, substitute route information 425c may be displayed. In this case, the substitute route information 425c is displayed in a different display format (e.g., different line type, color, or thickness) from those of the first route information 425a and the second route information 425b.

An estimated time of arrival (ETA) 424a and an estimated travel distance 424b to the destination are displayed in the estimated arrival time display area 424. The estimated arrival time display area 424 further includes a travel start notification button 426. The user 30 selects the traveling start notification button 426 when starting traveling of the vehicle 20. Thus, an input of notifying start of traveling of the vehicle 20 is given to the mobile terminal device 200, and the mobile terminal device 200 grasps a travel start timing of the vehicle 20.

When the user 30 has selected the travel start notification button 426 and the input of notifying start of traveling of the vehicle 20 has been given to the mobile terminal device 200, the first guidance information display unit 233 displays a route guidance screen.

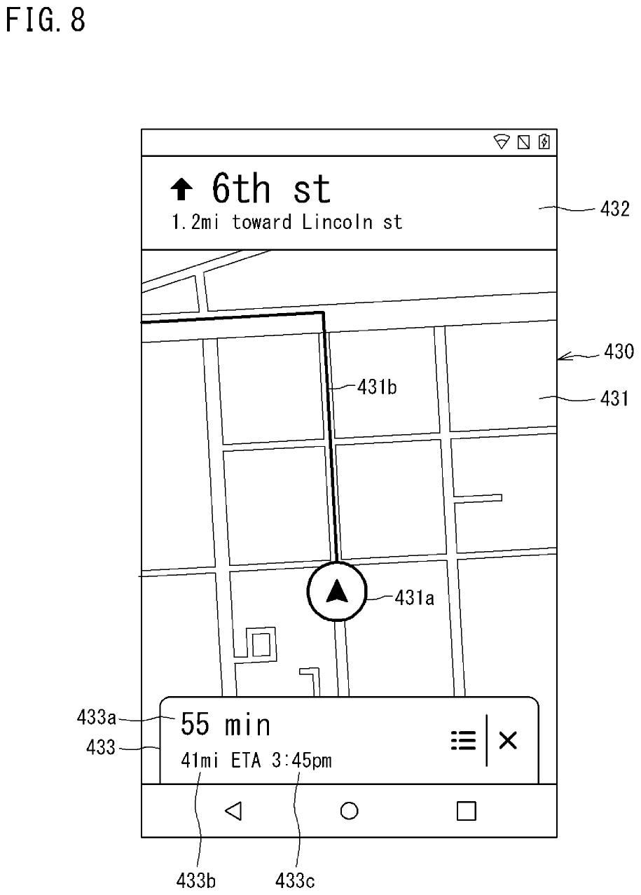

When the vehicle 20 has started traveling at the starting point, the first guidance information display unit 233 displays the route guidance screen including guidance information. The “guidance information” is information for guiding traveling of the vehicle 20 from the starting point to the relay point. For example, the guidance information is text information, sound information, or a symbol such as an arrow, indicating a direction in which the vehicle 20 should advance. In another example, the guidance information is text information indicating the name of a street on which the vehicle 20 should travel. FIG. 8 shows an example of the route guidance screen. The route guidance screen 430 includes a guide map display area 431, a guide text information display area 432, and a remaining time display area 433. The first guidance information display unit 233 is implemented by the processor 221 and the display unit 210.

The guide map display area 431 includes an enlarged map around the current location of the vehicle 20, a mark 431a indicating the current location of the vehicle 20, and route information 431b. The mark 431a and the route information 431b are superposed on the enlarged map. The mark 431a includes an arrow indicating a traveling direction of the vehicle 20. Text information guiding a route in which the vehicle 20 should travel, e.g., the name of a road on which the vehicle 20 should travel and a traveling direction (straight, right turn, or left turn), are displayed in the guide text information display area 432. The pieces of information displayed in the guide map display area 431 and the guide text information display area 432 are updated in real time in accordance with the location of the vehicle 20.

The remaining time display area 433 includes a remaining time 433a before an estimated time of arrival at the destination, an estimated travel distance 433b to the destination, and an estimated time of arrival 433c at the destination. The remaining time 433a is updated in real time in accordance with the current time. The estimated time of arrival 433c may be updated in real time in accordance with the speed of the vehicle 20, and the estimated travel distance 433b may be updated in real time when the vehicle 20 deviates from the route.

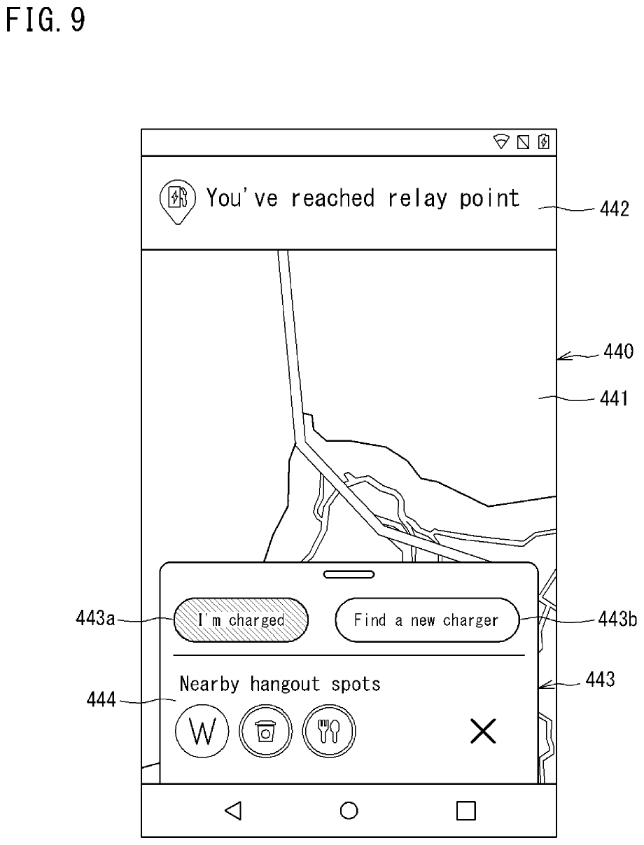

When the vehicle 20 has arrived at the relay point, the relay point arrival screen display unit 234 displays a relay point arrival screen. FIG. 9 shows an example of the relay point arrival screen. The relay point arrival screen 440 includes a map display area 441, an arrival notification area 442, and a user support information display area 443. The relay point arrival screen display unit 234 is implemented by the processor 221, the display unit 210, and the input unit 230.

The map display area 441 includes an enlarged map around the current location of the vehicle 20. The arrival notification area 442 includes text information, e.g., “You've reached relay point”, for notifying the user 30 of arrival at the relay point. Thus, the user 30 is notified of arrival at the relay point.

The user support information display area 443 includes: a charging completion button 443a for notifying that charging of the buttery of the vehicle 20 has been completed; a search request button 443b for requesting searching for another charging station; and a facility information display area 444 that displays facility information indicating facilities located around the relay point.

When the battery of the vehicle 20 has been charged at a charging station as the relay point, the user 30 selects the charging completion button 443a. Thus, a current battery level reception unit 235 described later displays a current battery level reception screen.

For example, if all charging stations at the relay point are being used, the user 30 can select the search request button 443b. When the search request button 443b has been selected, a charging station search request is transmitted to the server device 100. The server device 100 searches the charging station DB 107 for a charging station near the relay point, and transmits a search result to the mobile terminal device 200. In this case, the mobile terminal device 200 displays information for guiding the user 30 to the searched new charging station.

The facility information display area 444 includes one or a plurality of pieces of facility information. When displaying the relay point arrival screen 440, the mobile terminal device 200 requests the server device 100 to provide information of neighboring facilities. The server device 100 searches the facility DB 108 for facilities near the relay point, and transmits a search result to the mobile terminal device 200. Facility information received from the server device 100 is displayed in the facility information display area 444. The facility information displayed in the facility information display area 444 is, for example, a logo of a facility, or an icon indicating the type of a facility (restaurant, cafe, boutique, supermarket, drugstore, convenience store, etc.). The facility information may further include the distance from the current location of the vehicle 20, facility name, address, business hours, etc. For example, if the display screen of the mobile terminal device 200 is small, the user support information display area 443 may be enlarged according to an operation performed by the user 30, and the facility information including the distance from the current location of the vehicle 20, the facility name, address, business hours, etc., may be displayed in the enlarged user support information display area.

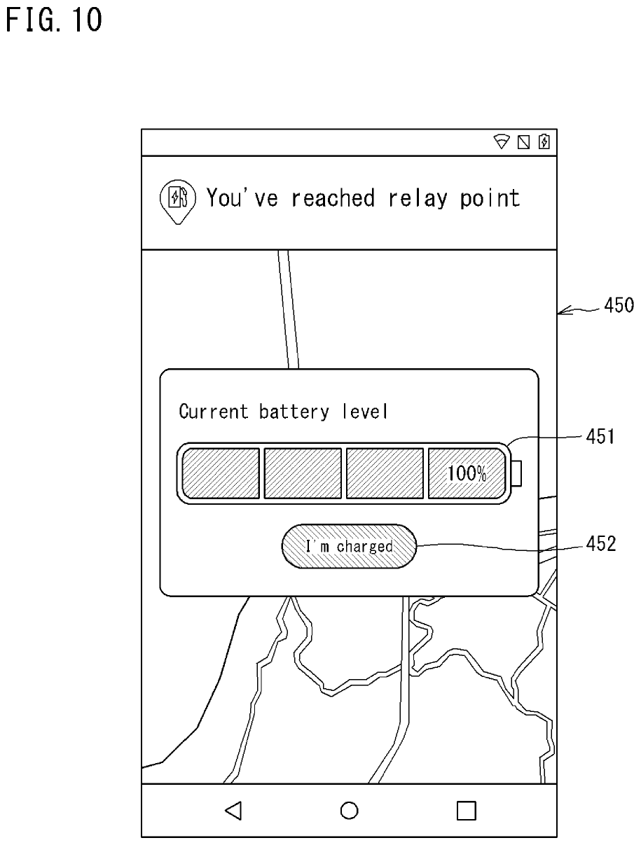

When the user 30 has selected the charging completion button 443a, the current battery level reception unit 235 displays the current battery level reception screen. FIG. 10 shows an example of the current battery level reception screen. The current battery level reception screen 450 is a screen on which the user 30 inputs the SOC of the battery having been charged at the charging station on the relay point. The current battery level reception screen 450 includes an input area 451 for inputting the current battery level, and a button 452 for requesting resumption of navigation. The current battery level reception unit 235 is implemented by the processor 221, the display unit 210, the input unit 230, and the wireless communication unit 240.

The user 30 can select the input area 451 and input the current SOC. For example, in the input area 451, a button or a slider for inputting the SOC level of the battery in a plurality of stages is displayed, and the user 30 can input the current SOC by performing a touch operation on the screen.

The SOC may be provided from an in-vehicle device installed in the vehicle 20. For example, the mobile terminal device 200 may receive, through wireless communication, the current SOC that is stored in an in-vehicle device for managing the battery.

After inputting the current SOC, the user 30 can request resumption of navigation by selecting the button 452. When the button 452 has been selected, data of the SOC (and the relay point and destination) inputted to the current battery level reception screen 450 is transmitted to the server device 100.

FIG. 4 is referred to again. The reception unit 111 receives the data of the SOC (and the relay point and destination) from the mobile terminal device 200.

The second route search unit 113 searches for a route from the relay point to the destination. That is, the search result of the first route search unit 112 is abandoned, and a route from the relay point to the destination is newly searched for. The second route search unit 113 searches for a route from the relay point (current location of the vehicle 20) to the destination, based on the current SOC of the vehicle 20 (the SOC received by the reception unit 111). At this time, the second route search unit 113 estimates the SOC at a timing when the vehicle 20 arrives at the destination. When the estimated SOC is lower than a predetermined value, the second route search unit 113 further determines a charging station as a relay point of the vehicle 20, and searches for a route, from the current location to the destination, including the new relay point. The charging station is determined within a range in which the vehicle 20 can arrive at the charging station with the SOC being equal to or higher than a predetermined value (e.g., 25%). That is, the second route search unit 113 estimates a distance that the vehicle 20 can travel with the SOC being equal to or higher than the predetermined value, and determines, as new relay point(s), one or a plurality of charging stations located near the route connecting the current location and the destination, from among charging stations located within the estimated distance from the starting point. Moreover, the second route search unit 113 searches for a route that connects the current location and the destination, and passes the new relay point.

The number of charging stations to be determined as new relay points by the second route search unit 113 is not limited to one, and a plurality of charging stations may be determined. That is, if the vehicle 20 cannot arrive at the destination from the current location unless the battery thereof is charged a plural number of times, the second route search unit 113 determines a plurality of charging stations as new relay points, and searches for a route that passes the charging stations. Moreover, the second route search unit 113 estimates again an arrival time at the destination in the case where the vehicle 20 travels the searched route. The second route search unit 113 may search for a substitute route different from the searched route.

The second route search unit 113 generates: first route information indicating a route in which the vehicle 20 travels with the SOC being equal to or higher than the predetermined value; and second route information indicating a route in which the vehicle 20 travels with the SOC being lower than the predetermined value. That is, the second route search unit 113 estimates a distance that the vehicle 20 can travel with the SOC being equal to or higher than the predetermined value. Then, the second route search unit 113 generates, as the first route information, information indicating a route, out of the searched route, in which the distance from the current location is within the estimated distance, and generates, as the second route information, information indicating a route, out of the searched route, in which the distance from the current location is greater than the estimated distance. The route information including the first route information and the second route information generated by the second route search unit 113, an estimated time of arrival, and substitute route information are transmitted by the transmission unit 114 to the mobile terminal device 200 together with map data.

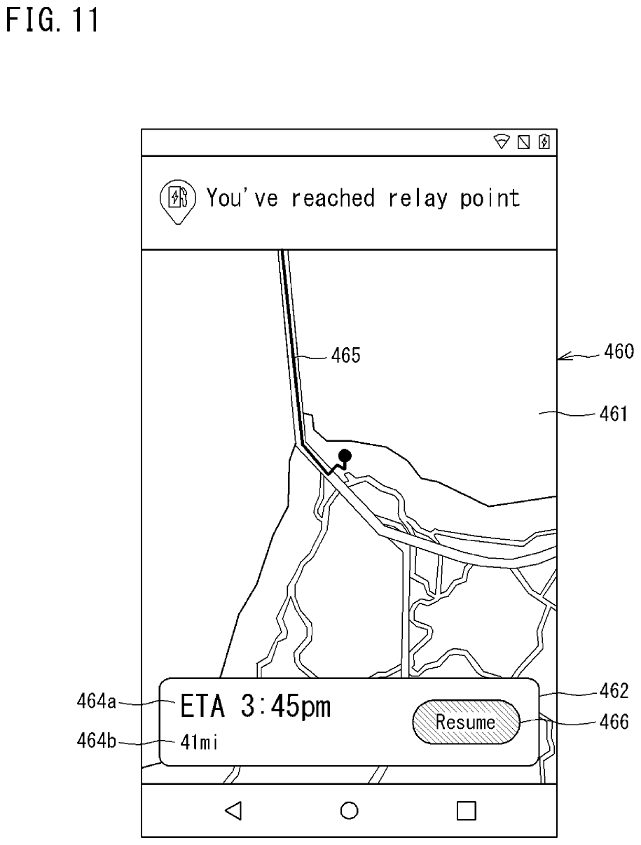

FIG. 5 is referred to again. The notification input screen display unit 236 displays a second route screen including the route information and the map received from the server device 100. FIG. 11 shows an example of the second route screen. The second route screen 460 includes a route information display area 461 and an estimated arrival time display area 462. The notification input screen display unit 236 is implemented by the processor 221, the display unit 210, and the input unit 230.

In the route information display area 461, information of the searched route is displayed while being superposed on the map. Regarding route information 465 displayed in the route information display area 461, the first route information indicating the route in which the vehicle 20 travels with the SOC being equal to or higher than the predetermined value and the second route information indicating the route in which the vehicle 20 travels with the SOC being lower than the predetermined value, may be displayed in different display formats so as to be distinguishable from each other. In the example of FIG. 11, only a part of the routes (only the first route information) is displayed because the scale of the map is large. In a specific example, the first route information is indicated by a solid line while the second route information is indicated by a broken line. The display formats are not limited to a solid line and a broken line. For example, the respective routes of the first route information and the second route information may be displayed in different colors.

In the route information display area 461, substitute route information may be displayed. In this case, the substitute route information is displayed in a different display format (e.g., different line type, color, or thickness) from those of the first route information and the second route information.

An estimated time of arrival 464a and an estimated travel distance 464b to the destination are displayed in the estimated arrival time display area 462. The estimated arrival time display area 462 further includes a travel resumption notification button 466. That is, the second route screen 460 is an example of an input screen that receives, from the user, an input for notifying resumption of traveling of the vehicle. When resuming traveling of the vehicle 20, the user 30 selects the travel resumption notification button 466. Thus, an input for notifying the resumption of traveling of the vehicle 20 is given to the mobile terminal device 200, and the mobile terminal device 200 grasps a travel resumption timing of the vehicle 20.

When the user 30 has selected the travel resumption notification button 466 and the input for notifying resumption of traveling of the vehicle 20 has been given to the mobile terminal device 200, the second guidance information display unit 237 displays a route guidance screen.

When the vehicle 20 has resumed traveling at the relay point, the second guidance information display unit 237 displays the route guidance screen including guidance information for guiding traveling of the vehicle 20 from the relay point to the destination (or a next relay point). Since the route guidance screen displayed by the second guidance information display unit 237 is similar in configuration to the route guidance screen displayed by the first guidance information display unit 233, repeated description is not necessary. The second guidance information display unit 237 is implemented by the processor 221 and the display unit 210.

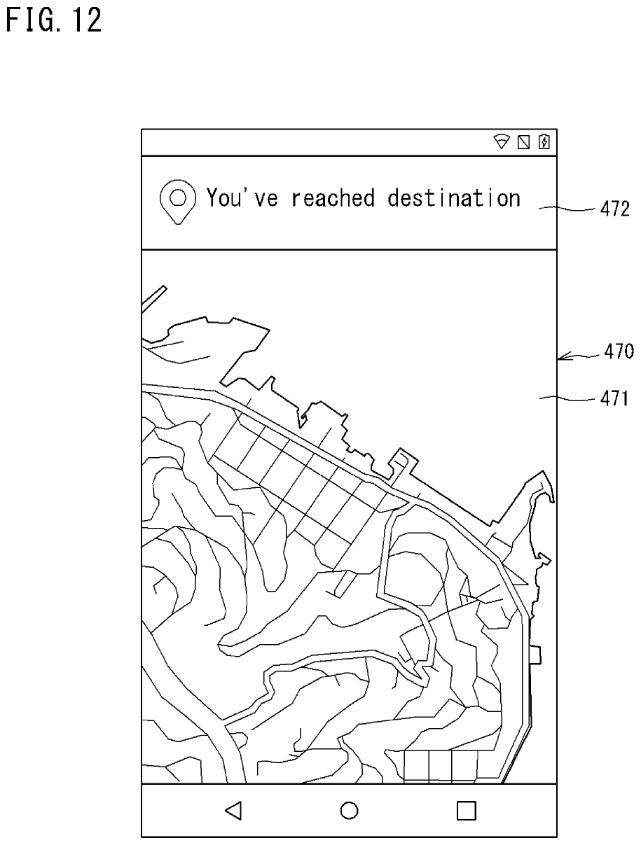

When the vehicle 20 has arrived at the destination, the destination arrival screen display unit 238 displays a destination arrival screen. FIG. 12 shows an example of the destination arrival screen. The destination arrival screen 470 includes a map display area 471 and an arrival notification area 472. The destination arrival screen display unit 238 is implemented by the processor 221 and the display unit 210.

The map display area 471 includes an enlarged map around the current location of the vehicle 20. The arrival notification area 472 includes text information, e.g., “You've reached destination”, for notifying the user 30 of arrival at the destination. Thus, the user 30 is notified of arrival at the destination.

[5. Operation of Navigation System]

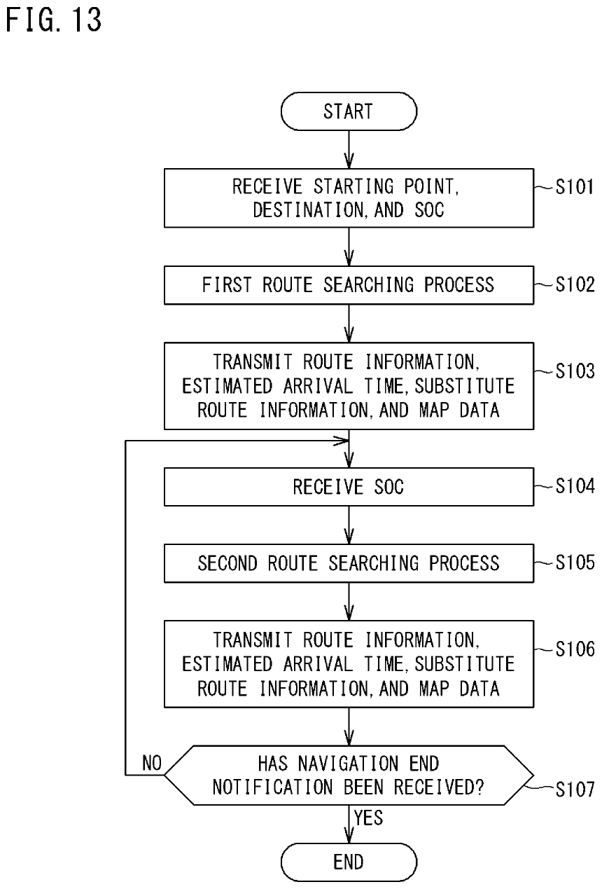

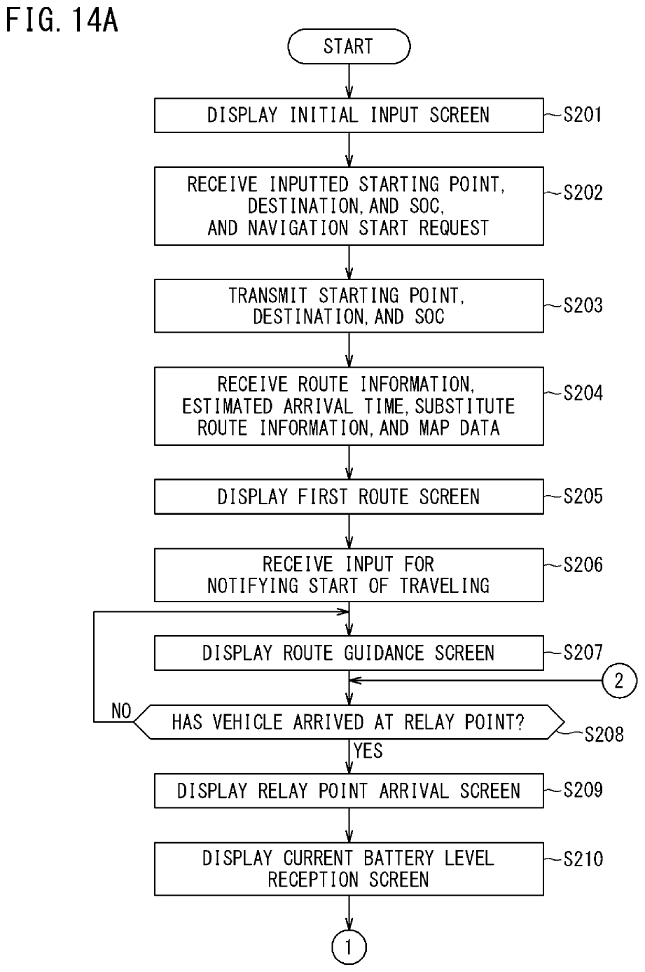

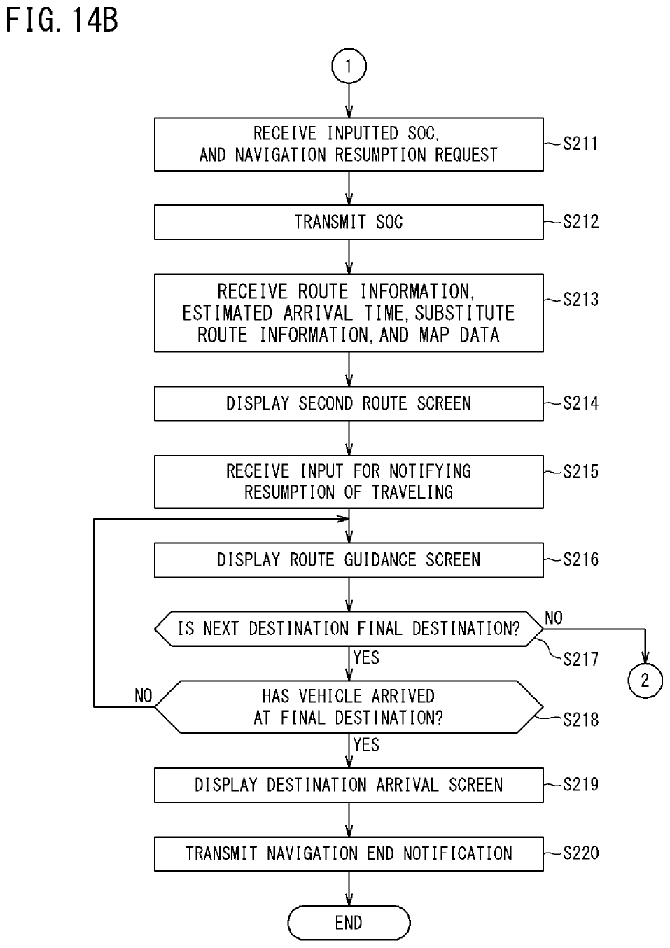

FIG. 13 is a flowchart showing an example of an operation flow of the server device 100 according to the present embodiment. FIG. 14A and FIG. 14B are flowcharts showing an operation flow of the mobile terminal device 200 according to the present embodiment. The functions of the navigation system are implemented by the processor 221 of the mobile terminal device 200 executing the client program 225, and the processor 101 of the server device 100 executing the server program 105.

FIG. 14A is referred to. When the user 30 uses a navigation service of the navigation system 10 when traveling using the vehicle 20 to a destination, the user 30 starts the client program 225. When the client program 225 has been started, the processor 221 causes the display unit 210 to display the initial input screen 410 (see FIG. 6) (step S201).

On the initial input screen 410, the user 30 inputs a starting point in the input area 411, a destination in the input area 412, and a current SOC in the input area 413. Moreover, the user 30 requests start of navigation by selecting the button 414. The processor 221 receives the inputted starting point, destination, and SOC, and the navigation start request (step S202). The mobile terminal device 200 transmits data of the starting point, destination, and SOC to the server device 100 (step S203).

FIG. 13 is referred to. The server device 100 receives the data of the starting point, destination, and SOC (step S101). The processor 101 of the server device 100 executes a first route searching process (step S102). In the first route searching process, the processor 101 determines, based on the received current SOC, a charging station as a relay point for the vehicle 20, and searches for a route, from the starting point to the destination, including the relay point. Moreover, in the first route searching process, the processor 101 also performs estimation of an arrival time and searching for a substitute route. The server device 100 transmits the route information, the estimated time of arrival, and the substitute route information which are acquired in the first route searching process, to the mobile terminal device 200 together with map data (step S103).

FIG. 14A is referred to again. The mobile terminal device 200 receives the route information, the estimated time of arrival, the substitute route information, and the map data (step S204). The processor 221 of the mobile terminal device 200 switches the display of the display unit 210 to the first route screen 420 (see FIG. 7) (step S205).

When starting traveling of the vehicle 20, the user 30 selects the travel start notification button 426 on the first route screen 420. Thus, the processor 221 receives an input for notifying start of traveling of the vehicle 20 (step S206).

Next, the processor 221 switches the display of the display unit 210 from the first route screen 420 to the route guidance screen 430 (step S207). Thus, traveling of the vehicle 20 to the relay point is guided.

The processor 221 determines whether or not the vehicle 20 has arrived at the relay point, based on location information acquired by the position sensor 250 (step S208). When the result of the determination is that the vehicle 20 has not yet arrived at the relay point (NO in step S208), display of the route guidance screen 430 is continued. When the result of the determination is that the vehicle 20 has arrived at the relay point (YES in step S208), the processor 221 switches the display of the display unit 210 from the route guidance screen 430 to the relay point arrival screen 440 (step S209).

When the battery of the vehicle 20 has been charged at the charging station as the relay point, the user 30 selects the charging completion button 443a. When the charging completion button 443a has been selected, the processor 221 switches the display of the display unit 210 from the relay point arrival screen 440 to the current battery level reception screen 450 (step S210).

The user 30 selects the input area 451 on the current battery level reception screen 450, and inputs the current SOC. Moreover, the user 30 requests resumption of navigation by selecting the button 452. The processor 221 receives the inputted SOC and the navigation resumption request (step S211). The mobile terminal device 200 transmits data of the SOC to the server device 100 (step S212).

FIG. 13 is referred to again. The server device 100 receives the data of the SOC (step S104). The processor 101 of the server device 100 executes a second route searching process (step S105). In the second route searching process, the processor 101, based on the received current SOC, searches for a route from the charging station as the current location (relay point) of the vehicle 20 to the destination. At this time, the processor 101 estimates an SOC at a timing when the vehicle 20 arrives at the destination. When the estimated SOC is lower than a predetermined value, the processor 101 further determines a charging station as a relay point of the vehicle 20, and searches for a route, from the current location to the destination, including the new relay point. Moreover, in the second route searching process, the processor 101 also performs estimation of an arrival time and searching for a substitute route. The server device 100 transmits the route information, the estimated time of arrival, and the substitute route information which are acquired in the second route searching process, to the mobile terminal device 200 together with map data (step S106).

FIG. 14B is referred to again. The mobile terminal device 200 receives the route information, the estimated time of arrival, the substitute route information, and the map data (step S213). The processor 221 of the mobile terminal device 200 switches the display of the display unit 210 to the second route screen 460 (see FIG. 11) (step S214).

When resuming traveling of the vehicle 20, the user 30 selects the travel resumption notification button 466 on the second route screen 460. Thus, the processor 221 receives an input for notifying resumption of traveling of the vehicle 20 (step S215).

Next, the processor 221 switches the display of the display unit 210 from the second route screen 460 to the route guidance screen 430 (step S216). Thus, traveling of the vehicle 20 to the destination or a next relay point is guided.

The processor 221 determines whether a next destination is a relay point or the final destination (step S217). When the next destination is a relay point (NO in step S217), the processor 221 shifts the process to step S208.

Meanwhile, when the next destination is the final destination (YES in step S217), the processor 221 determines whether or not the vehicle 20 has arrived at the destination, based on location information acquired by the position sensor 250 (step S218). When the result of the destination is that the vehicle 20 has not yet arrived at the destination (NO in step S218), display of the route guidance screen 430 is continued. When the result of the destination is that the vehicle 20 has arrived at the destination (YES in step S218), the processor 221 switches the display of the display unit 210 from the route guidance screen 430 to the destination arrival screen 470 (step S219). The processor 221 causes the display unit 210 to display the destination arrival screen 470, and transmits a navigation end notification to the server device 100 (step S220).

FIG. 13 is referred to again. The processor 101 of the server device 100 determines whether or not a navigation end notification has been received from the mobile terminal device 200 (step S107). When the server device 100 has not received the end notification (NO in step S107), the processor 101 returns the process to step S104. When there are a plurality of relay points, the second route searching process is executed each time the vehicle 20 has arrived at a relay point. Meanwhile, when the server device 100 has received the end notification (YES in step S107), the processor 101 ends the process. This is the end of the operation of the navigation system.

[6. Modification]

In the above embodiment, the mobile terminal device 200 is a client of the navigation system, and route information and travel guidance information are displayed on the display unit 210 of the mobile terminal device 200. However, the present disclosure is not limited thereto. For example, route information and travel guidance information may be displayed on an in-vehicle display device installed in the vehicle 20. In this case, the display device may be a client of the server device 100, or may be a stand-alone type navigation system including the function of the server device 100 and the function of the client.

[7. Effects]

As described above, the navigation system 10 according to the present embodiment guides traveling, to a destination, of a vehicle equipped with a battery for traveling. The navigation system 10 includes the server device 100, and the mobile terminal devices 200 which are display devices communicable with the server device 100. The server device 100 searches for a route, from a starting point to the destination, which includes a charging station as a relay point, based on a current battery level at the starting point. Each mobile terminal device 200 includes the display unit 210, and the control unit 220 which controls display on the display unit 210. The control unit 220 executes a route information display process, a first guidance information display process, a notification input screen display process, and a second guidance information display process. The route information display process is a process of causing the display unit 210 to display route information of a route, from the starting point to the destination, which has been searched by the server device 100. The first guidance information display process is a process of causing the display unit 210 to display guidance information for guiding traveling of the vehicle 20 from the starting point to the relay point when the vehicle 20 starts traveling at the starting point. The notification input screen display process is a process of causing the display unit 210 to display the second route screen 460 that receives, from the user, an input for notifying resumption of traveling of the vehicle 20, when the vehicle 20 resumes traveling after having arrived at the relay point. The second guidance information display process is a process of causing the display unit 210 to display guidance information for guiding traveling of the vehicle 20 from the relay point to the destination, when the input for notifying resumption of traveling of the vehicle 20 has been received on the second route screen 460. Thus, when charging of the battery has been performed at the charging station as the relay point, the user 30 performs an input for notifying resumption of traveling of the vehicle 20. Therefore, guidance can be resumed even if the user does not reset the destination.

In the mobile terminal device 200, the control unit 220 may execute a current battery level reception process of receiving a current battery level, when the vehicle 20 has arrived at the relay point. This allows the mobile terminal device 200 to grasp the current battery level before resumption of traveling.

The current battery level reception process may be a process of causing the display unit 210 to display the current battery level reception screen 450 for receiving, from the user 30, an input of a current battery level. This allows the user 30 to input the current battery level to the mobile terminal device 200.

Upon receiving the current battery level in the current battery level reception process, the control unit 220 may execute a second route information display process of causing the display unit 210 to display route information of a route, from the relay point to the destination, which has been searched for based on the received current battery level. Thus, the route from the relay point to the destination can be searched for based on the current battery level at the relay point.

The route information may include: the first route information 425a indicating a route in which the vehicle 20 travels with the current battery level being equal to or higher than a predetermined value; and the second route information 425b indicating a route in which the vehicle 20 travels with the current battery level being lower than the predetermined value. The first route information 425a and the second route information 425b may be displayed in different display formats so as to be distinguishable from each other. This allows the user 30 to distinguish the traveling route for which the current battery level is sufficient from a traveling route for which the current battery level is insufficient.

The control unit 220 may execute a relay point arrival screen display process of causing the display unit 210 to display the relay point arrival screen 440 including facility information indicating facilities located around the relay point, when the vehicle 20 has arrived at the relay point. This allows the user to be provided with information of facilities that the user 30 can drop in while the battery is being charged at the charging station.

[8. Supplementary Note]

The above embodiments are merely illustrative in all aspects and should not be recognized as being restrictive. The scope of the present disclosure is defined by the scope of the claims rather than by the description above, and is intended to include meaning equivalent to the scope of the claims and all modifications within the scope.

### REFERENCE SIGNS LIST

10 navigation system

20 vehicle

30 user

100 server device

101 processor

102 non-transitory memory

103 transitory memory

104 communication interface

105 server program

106 map data

107 charging station database

108 facility database

111 reception unit

112 first route search unit

113 second route search unit

114 transmission unit

200 mobile terminal device

210 display unit

220 control unit

221 processor

222 non-transitory memory

223 transitory memory

224 I/O interface

225 client program

230 input unit

231 initial input screen display unit

232 route information display unit

233 first guidance information display unit

234 relay point arrival screen display unit

235 current battery level reception unit

236 notification input screen display unit

237 second guidance information display unit

238 destination arrival screen display unit

240 wireless communication unit

250 position sensor

410 initial input screen

411 to 413 input area

414 button

420 first route screen

421 route information display area

422 current location information display area

423 destination information display area

424 estimated arrival time display area

424a estimated time of arrival

424b estimated travel distance

425 route information

425a first route information

425b second route information

425c substitute route information

426 travel start notification button

430 route guidance screen

431 guide map display area

431a mark

431b route information

432 guide text information display area

433 remaining time display area

433a remaining time

433b estimated travel distance

433c estimated time of arrival

440 relay point arrival screen

441 map display area

442 arrival notification area

443 user support information display area

443a charging completion button

443b search request button

444 facility information display area

450 current battery level reception screen

451 input area

452 button

460 second route screen

461 route information display area

462 estimated arrival time display area

464a estimated time of arrival

464b estimated travel distance

465 route information

466 travel resumption notification button

470 destination arrival screen

471 map display area

472 arrival notification area

500 network

1. A display device configured to display information for guiding traveling, to a destination, of a vehicle equipped with a battery for traveling, the display device comprising:
a display unit; and
a control unit configured to control display on the display unit, wherein
the control unit executes
a route information display process of causing the display unit to display route information of a route from a starting point to the destination, the route having been searched for based on a current level of the battery, and including a charging facility as a relay point,
a first guidance information display process of causing the display unit to display guidance information for guiding traveling of the vehicle from the starting point to the relay point, when the vehicle starts traveling at the starting point,
a notification input screen display process of causing the display unit to display an input screen that receives, from a user, an input for notifying resumption of traveling of the vehicle, when the vehicle resumes traveling after having arrived at the relay point, and
a second guidance information display process of causing the display unit to display guidance information for guiding traveling of the vehicle from the relay point to the destination, when the input for notification has been received on the input screen.

2. The display device according to claim 1, wherein
when the vehicle has arrived at the relay point, the control unit executes a current battery level reception process of receiving the current level of the battery.

3. The display device according to claim 2, wherein
the current battery level reception process is a process of causing the display unit to display a current battery level reception screen that receives, from the user, an input of the current level of the battery.

4. The display device according to claim 2, wherein
when the current level of the battery has been received in the current battery level reception process, the control unit executes a second route information display process of causing the display unit to display route information of a route, from the relay point to the destination, which has been searched for based on the received current level of the battery.

5. The display device according to claim 1, wherein
the route information includes: first route information indicating a route in which the vehicle travels with the current level of the battery being equal to or higher than a predetermined value; and second route information indicating a route in which the vehicle travels with the current level of the battery being lower than the predetermined value, and
the first route information and the second route information are displayed in different display formats so as to be distinguishable from each other.

6. The display device according to claim 1, wherein
when the vehicle has arrived at the relay point, the control unit executes a relay point arrival screen display process of causing the display unit to display a relay point arrival screen including facility information indicating facilities located around the relay point.

7. A navigation system configured to guide traveling, to a destination, of a vehicle equipped with a battery for traveling, the navigation system comprising:
a server device; and
a display device communicable with the server device, wherein
the server device is configured to search for a route, from a starting point to the destination, which includes a charging facility as a relay point, based on a current level of the battery at the starting point,
the display device includes
a display unit, and
a control unit configured to control display on the display unit, and
the control unit executes
a route information display process of causing the display unit to display route information of the route, from the starting point to the destination, which has been searched for by the server device,
a first guidance information display process of causing the display unit to display guidance information for guiding traveling of the vehicle from the starting point to the relay point, when the vehicle starts traveling at the starting point,
a notification input screen display process of causing the display unit to display an input screen that receives, from a user, an input for notifying resumption of traveling of the vehicle, when the vehicle resumes traveling after having arrived at the relay point, and
a second guidance information display process of causing the display unit to display guidance information for guiding traveling of the vehicle from the relay point to the destination, when the input for notification has been received on the input screen.

8. A display method of displaying, by using a display device, information for guiding traveling, to a destination, of a vehicle equipped with a battery for traveling, the method comprising:
displaying, by the display device, route information of a route from a starting point to the destination, the route having been searched for based on a current level of the battery, and including a charging facility as a relay point;
displaying, by the display device, guidance information for guiding traveling of the vehicle from the starting point to the relay point, when the vehicle starts traveling at the starting point;
displaying, by the display device, an input screen that receives, from a user, an input for notifying resumption of traveling of the vehicle, when the vehicle resumes traveling after having arrived at the relay point; and
displaying, by the display device, guidance information for guiding traveling of the vehicle from the relay point to the destination, when the input for notification has been received on the input screen.

9. A computer-readable non-transitory storage medium having, stored therein, a computer program for displaying information for guiding traveling, to a destination, of a vehicle equipped with a battery for traveling,
the computer program causing a computer including a display unit to execute:
a route information display process of causing the display unit to display route information of a route from a starting point to the destination, the route having been searched for based on a current level of the battery, and including a charging facility as a relay point;
a first guidance information display process of causing the display unit to display guidance information for guiding traveling of the vehicle from the starting point to the relay point, when the vehicle starts traveling at the starting point;
a notification input screen display process of causing the display unit to display an input screen that receives, from a user, an input for notifying resumption of traveling of the vehicle, when the vehicle resumes traveling after having arrived at the relay point; and
a second guidance information display process of causing the display unit to display guidance information for guiding traveling of the vehicle from the relay point to the destination, when the input for notification has been received on the input screen.
